(19) United States
(12) Patent Application Publication
(10) Pub. No.: US 2026/0172653 A1
(43) Pub. Date: Jun. 18, 2026

(54) METHOD, APPARATUS, DEVICE, MEDIUM, AND PROGRAM PRODUCT FOR ADJUSTING VIDEO

(71) Applicant: Beijing Zitiao Network Technology Co., Ltd., Beijing (CN)

(72) Inventor: Peng LV, Beijing (CN)

(21) Appl. No.: 19/423,917

(22) Filed: Dec. 17, 2025

(30) Foreign Application Priority Data
Dec. 17, 2024 (CN) 202411865191.8

(51) Int. Cl. H04N 21/854; H04N 21/44; H04N 21/462

(52) U.S. Cl. CPC H04N 21/854; H04N 21/44008; H04N 21/462

(57) ABSTRACT

The present disclosure relates to a method, an apparatus, a device, a media, and a program product for adjusting videos. The method comprises receiving a video stream, the video stream including a plurality of video frames. The method also comprises generating a plurality of sub-images based on video frames in the plurality of video frames, the sub-images in the plurality of sub-images being associated with objects in the plurality of objects in the video stream. The method also comprises determining a plurality of evaluation results corresponding to the plurality of objects. The method also comprises adjusting the plurality of sub-images based on the plurality of evaluation results.

### CROSS-REFERENCE TO RELATED APPLICATION(S)

This application claims priority to Chinese Application No. 202411865191.8 filed on Dec. 17, 2024, the disclosure of which is incorporated herein by reference in its entity.

### FIELD

The embodiment of the present disclosure generally relates to the field of image generation, and more particularly to a method, an apparatus, a device, a media, and a program product for adjusting videos.

### BACKGROUND

Currently, there are a variety of entertainment options available in live streaming scenarios. Viewers can pull a single streamer's video stream from a live streaming server to watch the streamer's live content, such as scenery, daily life, games, and so on. Viewers can also pull different video streams of a plurality of streamers through the live streaming server to watch their live content simultaneously. A plurality of streamers can also see each other's live content and adjust their own live streaming methods and content accordingly to achieve better live streaming effect and attract more viewers.

With the development of the live streaming industry, live entertainment content has become increasingly popular. Typically, live streaming entertainment content of individual streamers focused on personal talent or games, attracting viewers through their individual performance. If a plurality of streamers are connected for live streaming, more live streaming gameplay can be unlocked, allowing a plurality of streamers to compete for popularity in their live streaming rooms, which often attracts more viewers.

### SUMMARY

Embodiments of the present disclosure provide a method, an apparatus, a device, a medium, and a program product for adjusting a video.

According to a first aspect of the present disclosure, a method for adjusting a video is provided. The method comprises receiving a video stream, the video stream including a plurality of video frames. The method also comprises generating a plurality of sub-images based on a video frame of the plurality of video frames, a sub-image of the plurality of sub-images being associated with an object of a plurality of objects in the video stream. The method also comprises determining a plurality of evaluation results corresponding to the plurality of objects. The method also comprises adjusting the plurality of sub-images based on the plurality of evaluation results.

In a second aspect of the present disclosure, an apparatus for adjusting a video is provided. The apparatus comprises a video stream receiving module configured to receive a video stream, the video stream including a plurality of video frames; a sub-image generating module configured to generate a plurality of sub-images based on a video frame of the plurality of video frames, a sub-image of the plurality of sub-images being associated with an object in a plurality of objects in the video stream; an evaluation result determining module configured to determine a plurality of evaluation results corresponding to the plurality of objects; and a sub-image adjusting module configured to adjust the plurality of sub-images based on the plurality of evaluation results.

In a third aspect of the present disclosure, an electronic device is provided, comprising at least one processor; and a storage for storing at least one program, wherein the at least one program, when executed by the at least one processor, causes the at least one processor to implement the method according to the first aspect of the present disclosure.

In a fourth aspect of the present disclosure, a computer-readable storage medium is provided, on which a computer program is stored. When the program is executed by a processor, the method according to the first aspect of the present disclosure is implemented.

In a fifth aspect of the present disclosure, a computer program product is provided, comprising a computer program, which implements the method according to the first aspect of the present disclosure when executed by a processor.

It should be understood that the content described in this content section is not intended to limit the key or important features of the embodiments of the present disclosure, nor is it intended to limit the scope of the present disclosure. Other features of the present disclosure will become easy to understand through the following description.

### BRIEF DESCRIPTION OF THE DRAWINGS

The above and other objects, features and advantages of the present disclosure will become more apparent through a more detailed description of exemplary embodiments of the present disclosure with reference to the accompanying drawings, wherein like reference numerals generally represent like components throughout the exemplary embodiments of the present disclosure.

FIG. 1 illustrates a schematic diagram of an example environment in which the devices and/or methods of some embodiments of the present disclosure may be implemented;

FIG. 2 illustrates a schematic diagram of an example method for adjusting a video according to some embodiments of the present disclosure;

FIG. 3 illustrates a schematic diagram of a flow chart for adjusting a video according to some embodiments of the present disclosure;

FIG. 4 illustrates a schematic diagram of an example of a display area according to some embodiments of the present disclosure;

FIG. 5 illustrates a schematic diagram for adjusting a sub-image according to some embodiments of the present disclosure;

FIG. 6 illustrates a schematic diagram of a process in which a center point of a sub-image changes according to some embodiments of the present disclosure;

FIG. 7 illustrates a schematic block diagram of an apparatus for adjusting a video according to some embodiments of the present disclosure;

FIG. 8 illustrates a schematic block diagram of an example device suitable for implementing various embodiments of the present disclosure.

In the various drawings, the same or corresponding reference numerals denote the same or corresponding parts.

### DETAILED DESCRIPTION OF EMBODIMENTS

It is understood that the data involved in this technical solution (including but not limited to the data itself, the acquisition or use of the data) shall comply with the requirements of relevant laws, regulations and relevant provisions.

It is understandable that before using the technical solutions disclosed in the various embodiments of this disclosure, the type, scope of use, usage scenarios, etc. of the personal information involved in this disclosure should be informed to the user and the user's authorization should be obtained in an appropriate manner in accordance with relevant laws and regulations.

For example, upon receiving a user's active request, a prompt message is sent to the user to clearly inform the user that the requested operation will require the acquisition and use of the user's personal information. This allows the user to independently choose whether to provide personal information to the electronic device, application, server, storage medium, or other software or hardware that performs the operations of the disclosed technical solution based on the prompt message.

As an optional but non-limiting implementation, in response to receiving a user's active request, the prompt information may be sent to the user in the form of a pop-up window, in which the prompt information may be presented in text form. Furthermore, the pop-up window may also contain a selection control for the user to select “agree” or “disagree” to provide personal information to the electronic device.

It is understandable that the above notification and user authorization process are merely illustrative and do not limit the implementation of the present disclosure. Other methods that comply with relevant laws and regulations may also be applied to the implementation of the present disclosure.

The following further describes embodiments of the present disclosure in more detail below with reference to the accompanying drawings. Although certain embodiments of the present disclosure are shown in the accompanying drawings, it should be understood that the present disclosure can be implemented in various forms and should not be construed as limited to the embodiments described herein. Rather, these embodiments are provided to provide a more thorough and complete understanding of the present disclosure. It should be understood that the drawings and embodiments of the present disclosure are for illustrative purposes only and are not intended to limit the scope of protection of the present disclosure.

In the description of the embodiments of the present disclosure, the term “including” and similar terms should be understood as open inclusion, that is, “including but not limited to.” The term “based on” should be understood as “based at least in part on.” The term “one embodiment” or “the embodiment” should be understood as “at least one embodiment.” The terms “first,” “second,” etc. may refer to different or the same objects. Other explicit and implicit definitions may also be included below.

There are still many problems to be solved, when watching live streaming video. For example, In the case of multi-streamers connected live streaming, multi-person live streaming can be conducted through match (PK). In this scenario, the live video streams of each streamer are combined on the live streaming end and then transmitted to the viewer's client via the content distribution platform for display. When a plurality of streamers start a live match, each streamer will have a score or level to indicate their lead or lag. In the traditional scheme, when a number of streamers start a match, it is necessary to adjust the image parts of the corresponding streamers to show the changes of the leading or lagging state of the match. For example, the image part of the streamer temporarily in the lead may be enlarged, while the image part of the streamer temporarily lagging behind may be reduced. During the match, the live streaming end can transmit the adjusted live video stream to the viewer's client.

In the aforementioned traditional solution, after the live video stream is generated, viewers can pull the video streams of the streamers separately through the client. When the match score or streamer level changes, the streamer client detects the change of the match score or streamer level to update the size of the image area of different streamers in the corresponding video stream, after adjusting the size of the image area, the stream is then transmitted to the viewer's client for display. In this traditional solution, both the client and the live streaming client obtain the match score or streamer level through the match server. Since the streamer client needs to merge the video streams after obtaining the score or level before transmitting them to the client for display, at this time, the video streams received by the client will have a relatively high delay. Therefore, after the match score or streamer level changes on the client, it takes some time for the video image to change. For viewers, this kind of display effect with high delay will lead to poor viewing experience, which can not further attract viewers to continue watching, and will affect the user experience.

To at least address the above and other potential issues, embodiments of the present disclosure provide a method for adjusting a video. In this method, a video stream may be received at a computing device. The video stream includes a plurality of video frames. Subsequently, after receiving the video stream, the computing device generates a plurality of sub-images based on the video frames in the video stream. The sub-image in the plurality of sub-images are associated with objects of the plurality of objects in the video stream. The computing device then determines a plurality of evaluation results corresponding to the plurality of objects. Finally, after receiving the plurality of evaluation results, the computing device adjusts the plurality of sub-images for display in a display area.

Through this method, the video frame is divided into a plurality of sub-images associated with a plurality of objects, so that the display of the sub-images can be adjusted on the client according to the changes in the evaluation results, avoiding the inconsistency between the evaluation results and the display of the video stream caused by the delay of the video stream, and improving the user experience.

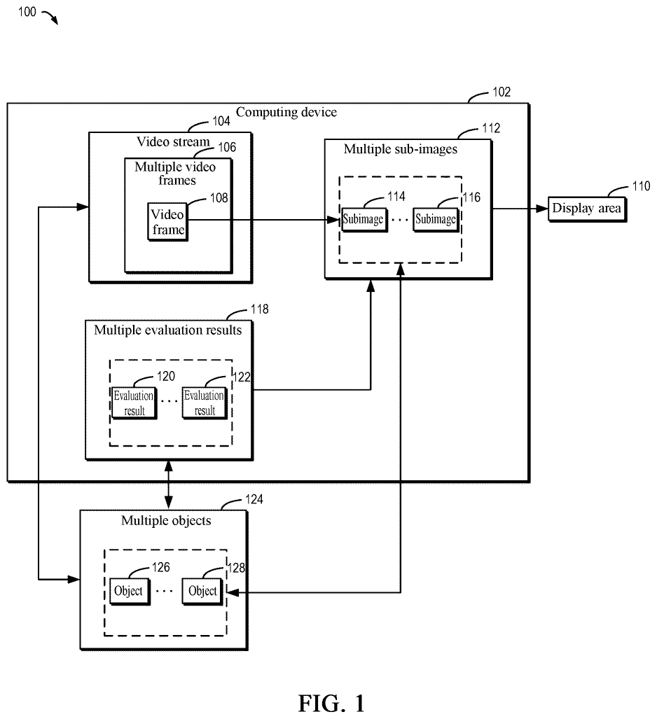

The following further describes embodiments of the present disclosure in detail with reference to the accompanying drawings. FIG. 1 illustrates an example environment in which the devices and/or methods of embodiments of the present disclosure may be implemented. In environment 100, a computing device 102 first receives a video stream 104. Video stream 104 includes a plurality of video frames 106, which include a video frame 108. After receiving video stream 104, computing device 102 may generate a plurality of sub-images 112 based on a video frame 108 in video stream 104. Each sub-image of sub-images 112 is associated with an object in a plurality of objects 124 in the video stream. For example, sub-images 114 through 116 are associated with objects 126 through 128, respectively. For example, the objects may be corresponding streamers or streamer devices in a live streaming match. Computing device 102 then receives a plurality of evaluation results 118 corresponding to the plurality of objects 124. Among the plurality of evaluation results 118, evaluation results 120 to 122 are respectively associated with objects 126 to 128. Finally, after receiving the plurality of evaluation results 118, the computing device 102 adjusts the plurality of sub-images 112 for display in the display area 110.

Examples of computing device 102 include, but are not limited to, personal computers, server computers, handheld or laptop devices, mobile devices (such as mobile phones, personal digital assistants (PDAs), media players, etc.), multi-processor systems, consumer electronics, minicomputers, mainframe computers, distributed computing environments that include any of the above systems or devices, and the like.

As shown in FIG. 1, computing device 102 can receive a video stream 104. For example, during a match between two live streamers, viewers of each live streamer can watch the live streams through clients. During this process, the clients can obtain the video streams from streamer ends, such as by pulling the video streams from a content distribution network. Among them, the video stream 104 can include a plurality of video frames 106.

In some embodiments, each video frame in the plurality of video frames 106 is associated with objects 126 to 128. For example, the plurality of objects 124 may be streamers performing a match or their devices. A video stream generated at a streamer end may include information about a plurality of streamers. Therefore, each video frame in the video stream is generated by synthesizing video images from the plurality of streamers.

In some embodiments, if there are two streamers participating in the match, video stream 106 presents information about the match between the two streamers. In this case, video frame 108 in video stream 104 includes image information of both streamers, with each streamer's image occupying a portion of the video frame. In some embodiments, if there are three streamers participating in the match, video stream 104 presents information about the match between the three streamers. In this case, video frame 108 in video stream 104 includes image information of all three streamers.

After receiving the video stream 104, the computing device 102 further processes the plurality of video frames 106 in the video stream 104. During this process, the computing device 102 processes each of the plurality of video frames and generates a plurality of sub-images 112 based on their correspondence with the plurality of objects 124. Therefore, each sub-image in the plurality of sub-images 112 is associated with one of the plurality of objects 124 in the video stream. It will be appreciated that the number of sub-images of the plurality of sub-images 112 is the same as the number of objects of the plurality of objects 124 and the number of evaluation results of the plurality of evaluation results 118. In some embodiments, at the initial moment of a match, the size of the image area associated with each object in the corresponding video frames is the same.

Then, the computing device 102 also receives a plurality of evaluation results 118 corresponding to a plurality of objects 124. Among the plurality of evaluation results 118, evaluation results 120 to 122 are associated with objects 126 to 128, respectively. For example, when the plurality of objects are a plurality of streamers, the plurality of evaluation results 118 indicate the evaluation results of the plurality of streamers, and each streamer has an evaluation result. In one example, the evaluation result refers to a score, in which case the plurality of evaluation results correspond to a plurality of scores, and each streamer has a corresponding score. In another example, the evaluation result refers to a level, and the plurality of evaluation results correspond to a plurality of levels, such as levels A, B, C, and D, and each streamer has a corresponding level. The above examples are only used to describe the present disclosure and are not specific limitations of the present disclosure. The evaluation results can be any suitable evaluation indicators.

The plurality of evaluation results 118 are the same in the initial state. In one example, when the evaluation result is a score, the initial evaluation result may be 0. Additionally, the scores in the plurality of scores 118 are non-negative integers. In another example, when the evaluation result is a level, the initial evaluation result may be result A. After receiving the plurality of evaluation results 118, the computing device 102 adjusts the plurality of sub-images 112 for display in the display area 110. The evaluation result is not only used to adjust the size of the sub-images, but also to determine the proportion of each sub-image in the display area, so that the adjusted sub-images are displayed in the display area. Additionally, when the plurality of evaluation results 118 corresponding to the plurality of sub-images 112 are all identical, the proportion of the sub-images in the plurality of sub-images 112 occupying the display area is also the same.

In some embodiments, when receiving the initial video frame of a video stream, the initial evaluation results are the same, and the display area of each sub-image corresponding to each object will be the same. For example, if the video stream is for two objects, the display area is calculated as 100%, after divided by 2, 50% of the display area is allocated to each of the two sub-images.

Through this method, the video frame is divided into a plurality of sub-images associated with a plurality of objects, so that the display of the sub-images can be adjusted on the client according to the changes in the evaluation results, avoiding the inconsistency between the evaluation results and the display of the video streams caused by the delay of the video streams, and improving the user experience.

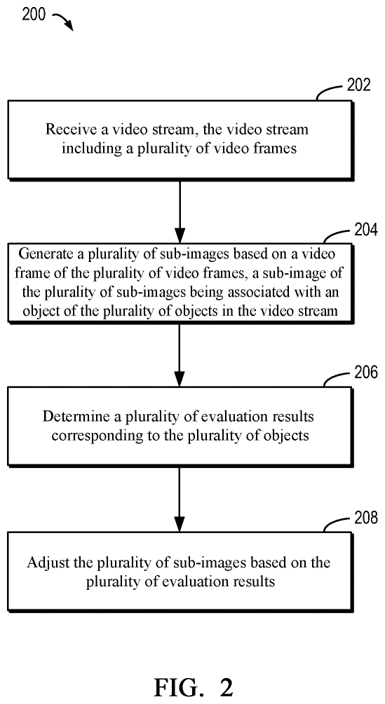

A schematic diagram of an example environment in which devices and/or methods according to some embodiments of the present disclosure may be implemented is described above in conjunction with FIG. 1. A schematic diagram of an example method for adjusting a video according to some embodiments of the present disclosure is described below in conjunction with FIG. 2. The method in FIG. 2 may be executed by the computing device 102 in FIG. 1 or any suitable computing device.

FIG. 2, in the example method 200, at block 202, the computing device 102 receives a video stream comprising a plurality of video frames. For example, a live streaming end may upload the generated video stream to a content distribution network, and a client watching the live streaming may pull the video stream from the content distribution network for viewing by the user.

In some embodiments, the video stream 104 is associated with a plurality of objects 124. For example, in a scenario where a plurality of live streamers are participating in a match, each live streamer can obtain video stream information of other live streamers, and then these video streams are merged to generate a video stream 104 for that live streamer. Therefore, the video frame 108 of the video stream 104 includes image portions for a plurality of live streamers.

Then, at block 204, computing device 102 generates a plurality of sub-images based on a video frame of the plurality of video frames, wherein the sub-images of the plurality of sub-images are associated with objects of the plurality of objects in the video stream. After acquiring the video stream, the computing device processes the video frames in the video stream to obtain an image portion corresponding to each object to generate the plurality of sub-images.

In some embodiments, after receiving a plurality of video frames 106 from a video stream 104, a copy for a video frame 108 is generated when processing a video frame 108. In this case, a plurality of copies can be generated based on the number of objects 124 corresponding to video stream 104. A plurality of sub-images are then generated using these a plurality of copies. For example, for two objects, two copies of a video frame 108 can be generated, and then two sub-images are generated using these two copies. Alternatively, the total number of copies generated and the number of video frames is the same as the number of objects, and then a plurality of sub-images are generated using these video frames and the copies. For example, if there are two objects, one copy can be generated, and then video frame 108 and the generated copy can be used to generate two sub-images associated with the two objects.

A video frame 108 of among the plurality of video frames 106 received by computing device 102 includes metadata, which can be used to determine a location of an image portion corresponding to an object of the plurality of objects 124 in the video frame. For example, the metadata includes vertex coordinates, a height, and a width of the image portion corresponding to the object of the plurality of objects 124. Therefore, computing device 102 can determine the location of the image portion in the video frame using the vertex coordinates, a height, and a width.

After determining the vertex coordinates, a height, and a width of the sub-image corresponding to the object in the plurality of objects 124, the video frame or a copy corresponding to the video frame is cropped to generate the corresponding sub-image. In some embodiments, the video frame 108 can be directly segmented to obtain the plurality of sub-images 112.

Next, at block 206, computing device 102 determines a plurality of evaluation results corresponding to the plurality of objects. Evaluation results 120 through 122 of the plurality of evaluation results 118 are associated with objects 126 through 128, respectively. For example, in the context of a streamer match, the plurality of objects may be streamers, and the plurality of evaluation results 118 may be scores for the streamers or a plurality of levels for the streamers.

In some embodiments, a plurality of evaluation results 118 for a plurality of objects 124 are the same in the initial state. In some embodiments, when the evaluation result is a score, the score can also be expressed in the form of a dynamic effect. In one example, the score is displayed in the target application corresponding to the display area 110 in the form of a colored bar, and when the score increases, the colored bar becomes longer; when the score decreases, the colored bar becomes shorter. In another example, the score is expressed in the form of a balloon in the target application corresponding to the display area 110, and when the score increases, the balloon becomes larger. Additionally, there is a preset threshold for the maximum display area of the balloon. Additionally, the numerical value of the score can also be displayed. In some embodiments, when the evaluation result is a level, colored bars of different lengths or balloons of different sizes can be displayed according to different levels. The above examples are only used to describe the present disclosure and are not specific limitations of the present disclosure.

In some embodiments, taking the live streaming scenario as an example, the plurality of objects 124 are a plurality of streamers, and the plurality of streamers compete with each other to determine the evaluation results obtained by the streamers. The evaluation results can be mainly determined by viewer likes, viewer comments, viewer sharing of the live streaming room and/or viewer rewards and gifts, etc.

Finally, at block 208, the computing device 102 adjusts the plurality of sub-images based on the plurality of evaluation results. After obtaining the plurality of evaluation results, the computing device 102 may adjust each of the plurality of sub-images and display the adjusted images in the display area.

In some embodiments, if, upon receiving a plurality of sub-images 112, the evaluation results corresponding to the sub-images are all initial values, each sub-image will be displayed evenly in the display area. For example, if a video stream corresponds to two objects, two sub-images may be generated for each video frame in the video stream. If both sub-images have a score of 0, the two sub-images will share the display area equally.

In some embodiments, when adjusting an image, only sub-images whose image occupancy proportion exceeds a threshold are enlarged, while sub-images whose image occupancy proportion does not exceed the threshold are not enlarged or reduced. For example, when two objects are present, two sub-images can be generated using video frame 108 in video stream 106. If it is determined that the proportion of one image portion occupying the display area larger than 50% of the initial proportion based on the evaluation results, then the image portion needs to be enlarged. If it is determined that the proportion of the other image portion occupying the display area is less than 50% based on the evaluation results, then the image does not need to be enlarged or reduced.

In some embodiments, when the evaluation result is a score, the proportion of the display area occupied by an image portion can be determined by dividing the score of the object by the total score of the plurality of objects. For example, if the score for one of two sub-images is 300 and the score for the other is 200, the display proportion of the first sub-image in the display area is calculated as 300/(300+200)=0.6. In other words, in this case, the display proportion of the first sub-image in the display area is 60%. In some embodiments, when the evaluation result is a level, the display proportions corresponding to different levels can be pre-set.

When adjusting the target sub-image, the calculated display proportion is first compared to a threshold. If the calculated display proportion is greater than the threshold, the sub-image is enlarged. Additionally, if the calculated display proportion of the target sub-image is less than the threshold, the sub-image is not enlarged or reduced, and the following operations are performed instead.

In addition to adjusting the sub-image, the computing device 102 may also determine a sub-area in the display area 130 that corresponds to the sub-image, and then display the adjusted sub-image in the sub-area.

Additionally, the computing device 103 may assign the sub-image to the target view component, and further adjust the size of the sub-image by adjusting the size of the view component according to the display proportion calculated above.

In the case that the sub-image is enlarged, the first height of the enlarged sub-image exceeds the second height of the display area 110, wherein the second height is a fixed height and does not change with the change of the sub-image. In this case, it is necessary to remove the content of the sub-image that exceeds the second height of the display area.

One way is to crop the content of the sub-image that exceeds the second height. In this case, the computing device 102 first determines the content that exceeds the area, and then the computing device 102 performs edge cropping along the upper border and/or lower border of the display area 110 to crop out the content that exceeds the area.

Another method is to use the background area outside the display area 110 to cover the content in the target sub-image that exceeds the second height. In this case, the computing device overlays the background area layer on the content in the exceeding area, thereby hiding the content in the exceeding area under the background layer. Additionally, during the sub-image enlargement process, the sub-area corresponding to the sub-image is simultaneously enlarged, and other sub-areas of the display area 110 are simultaneously reduced.

If the calculated display proportion of the target sub-image is smaller than the threshold, the target sub-image is horizontally translated as other sub-images are enlarged, part of the content is removed from the display area 110, and part of the image content is covered by other sub-images.

Additionally, when one of the two evaluation results is always in the initial state or the difference between the higher and lower evaluation results is greater than a predetermined threshold, the display proportion of the sub-image corresponding to the lower evaluation result is no less than a predetermined display proportion. For example, when one of the two scores is always 0 or the difference between the higher and lower scores is greater than 100, the display proportion of the sub-image corresponding to the score of 0 or the lower score is no less than 25% of the display area 110. Additionally, sub-images can be rendered onto a view component, so the above-mentioned process of resizing the image can be achieved by adjusting the view component in which the image is located.

Through this method, the video frame is divided into a plurality of sub-images associated with a plurality of objects, so that the display of the sub-images can be adjusted on the client according to the changes in the evaluation results, avoiding the inconsistency between the evaluation results and the display of the video stream caused by the delay of the video stream, and improving the user experience.

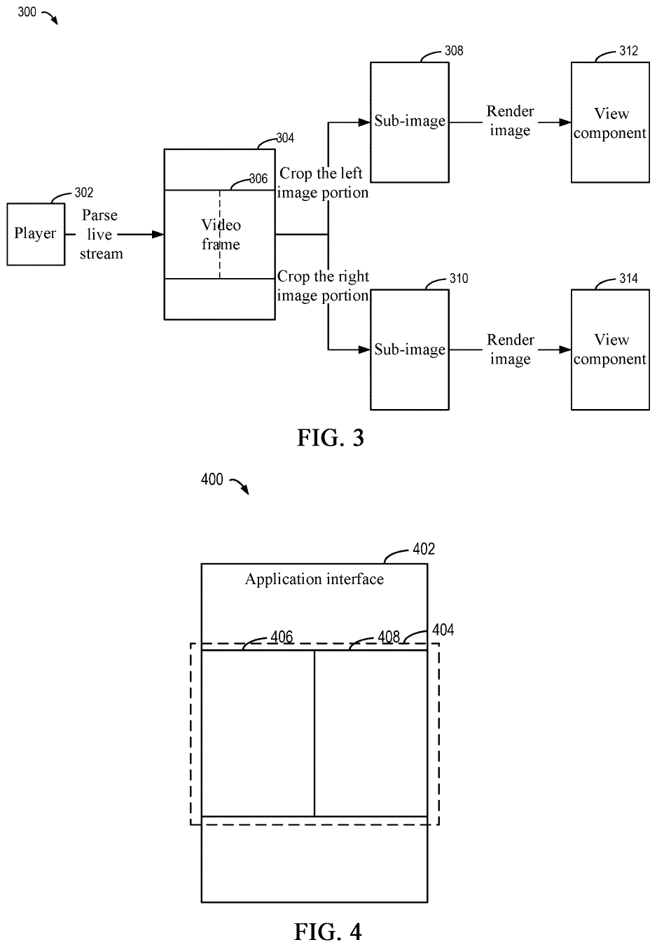

A schematic diagram of an example method for adjusting a video according to some embodiments of the disclosure is described above in conjunction with FIG. 2. A schematic diagram of a flowchart for adjusting a video according to some embodiments of the disclosure is described below in conjunction with FIG. 3. The example of FIG. 3 may be executed by the computing device 102 shown in FIG. 1 or any other suitable device.

In the example 300 shown in FIG. 3, a live streaming scenario involving two streamers competing is used as an example. First, a live stream or video stream is received at a player 302, which is then parsed. After the live stream or video stream is parsed, video frames 306 within the video stream will be displayed in an application interface 304. The acquired live stream or video stream is a single, integrated video stream formed by merging the live streams of two streamers (streamer A and streamer B) at the streamer end.

After receiving video frame 306, the computing device determines the vertex coordinates, a height, and a width of the corresponding image portions of the two streamers. The computing device then crops the left image portion or the right image portion of the video frame or a copy thereof to generate corresponding sub-images 308 and 310.

Additionally, sub-image 308 and sub-image 310 are rendered separately, so as to render sub-image 308 and sub-image 310 respectively onto view component 312 and view component 314. In this case, the size of the sub-image can be further adjusted by adjusting the size of the view component.

A schematic diagram of a flowchart for adjusting a video according to some embodiments of the disclosure is described above in conjunction with FIG. 3. A schematic diagram of an example of a display area according to some embodiments of the disclosure is described below in conjunction with FIG. 4.

In the example 400 shown in FIG. 4, combined with the previous example 300, there is a display area 404 in the application interface 402, wherein the display area 404 is used to display a sub-image 406 and a sub-image 408.

In some embodiments, the height of display area 404 is fixed, and sub-image 406 and sub-image 408 are displayed in a left-right arrangement. Additionally, sub-image 406 and sub-image 408 can also be displayed in a top-bottom arrangement. This application does not impose any limitation on this.

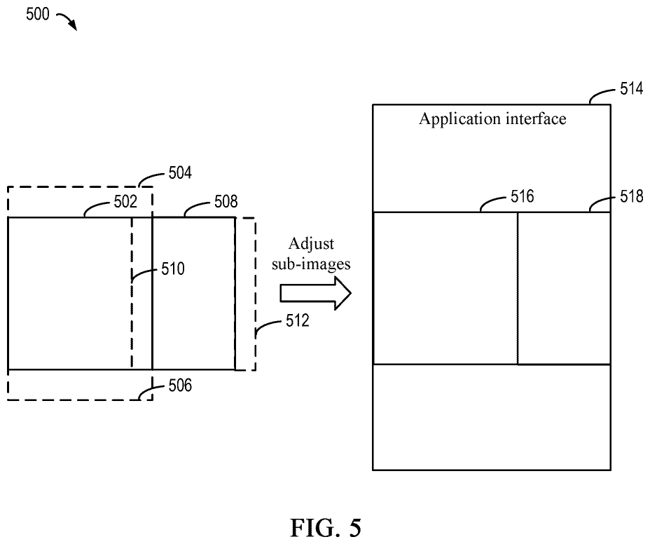

A schematic diagram of an example for adjusting a video display area according to some embodiments of the disclosure is described above in conjunction with FIG. 4. A schematic diagram of adjusting a sub-image according to some embodiments of the disclosure is described below in conjunction with FIG. 5.

In the example 500 shown in FIG. 5, combined with previous examples 300 and 400, when sub-image 502 and sub-image 508 have the same corresponding scores, sub-image 502 and sub-image 508 are both displayed in the display area at a display proportion of 50%.

When the score of streamer A (corresponding to sub-image 502) exceeds the score of streamer B (corresponding to sub-image 508), sub-image 502 is adjusted (i.e., enlarged). Content 504 and 506 in the enlarged sub-image exceed the display area. At this time, the content 504 and 506 in sub-image 502 that exceeds the second-height of the display area needs to be removed.

One way is to crop the content in the sub-image 502 exceeding the second height. Specifically, the content exceeding the area is determined, and then cropped along the upper and/or lower borders of the display area to crop the content 504 and content 506 exceeding the area.

Another method is to use the background image outside the display area of the application interface 514 to cover the content 504 and content 506 in the sub-image 502 that exceeds the second height. Specifically, the content 504 and content 506 that exceeds the area are hidden under the background layer.

At this time, the sub-image 508 is not adjusted in size, the sub-image 502 will cover the content 510 part of the sub-image 508, and the sub-image 508 will be horizontally translated in the same direction as the sub-image 504 is enlarged, and the content 512 will be moved out of the display area.

After the adjustment is completed, the adjusted partial content 516 of the sub-image 504 is displayed in the corresponding sub-area in the display area of the application interface 514, and the partial content of the sub-image 508 is displayed in the corresponding sub-area.

Additionally, during the zooming-in process of the target sub-image, the target sub-area displaying the target sub-image is synchronously enlarged, and another sub-area of the display area 110 is synchronously reduced.

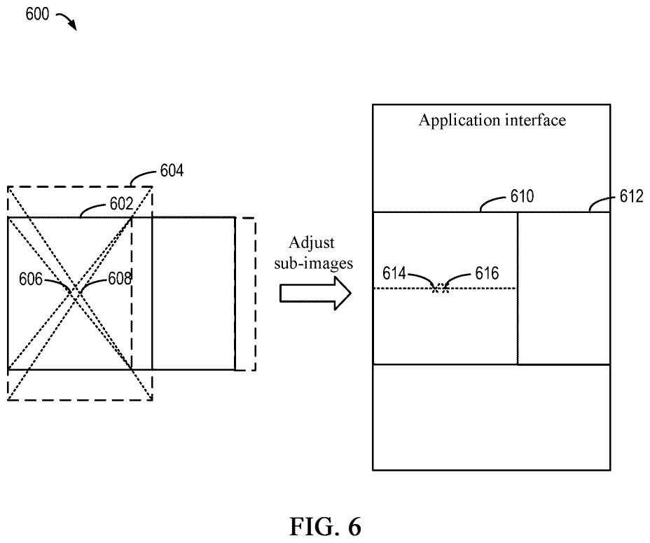

The schematic diagram for adjusting a sub-image according to some embodiments of the disclosure is described above in conjunction with FIG. 5. The schematic diagram for adjusting the center point change process of a sub-image of a video according to some embodiments of the disclosure is described below in conjunction with FIG. 6.

Example 600 shown in FIG. 6, combined with the previous Example 500, during the adjustment process, the center point 606 of the atomic image 602 and the center point 608 of the adjusted sub-image 604 are located on the same horizontal line. Furthermore, center point 606 is the center point of the atomic area, and center point 608 is the center point of the adjusted sub-area.

After adjustment, the adjusted sub-image 610 is displayed in the background image. It can be seen that the movement trajectory of center point 614 (original center point 606) to center point 616 (original center point 608) is at the same horizontal position. At this time, sub-image 612 is partial content of the corresponding atomic image.

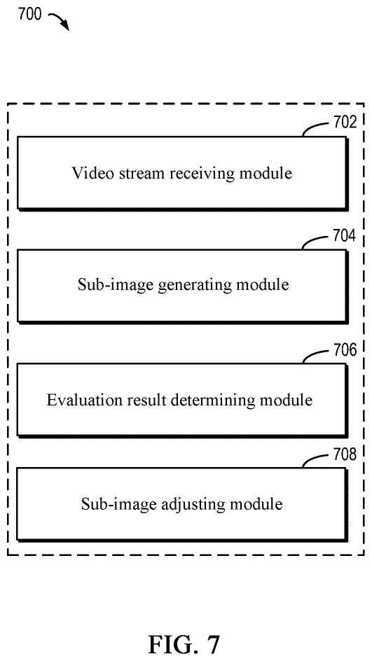

FIG. 7 shows a schematic block diagram of an apparatus for adjusting a video according to some embodiments of the present disclosure. As shown in FIG. 7, apparatus 700 comprises a video stream receiving module 702 configured to receive a video stream, the video stream comprising a plurality of video frames; a sub-image generating module 704 configured to generate a plurality of sub-images based on a video frame of the plurality of video frames, wherein a sub-image of the plurality of sub-images are associated with an object of the plurality of objects in the video stream; an evaluation result determining module 706 configured to determine a plurality of evaluation results corresponding to the plurality of objects; and a sub-image adjusting module 708 configured to adjust the plurality of sub-images based on the plurality of evaluation results.

In some embodiments, the sub-image generation module 704 comprises a sub-image position determining module, configured to determine the position of a sub-image corresponding to an object of a plurality of objects in the video frame based on metadata of the video frame; and a sub-image acquiring module, configured to acquire the sub-image based on the position.

In some embodiments, the sub-image acquisition module comprises: a video frame copy generating module configured to generate a copy of the video frame based on the video frame; and a copy cropping module configured to acquire a sub-image by cropping the copy based on position.

In some embodiments, the metadata includes vertex coordinates, a height, and a width of a sub-image corresponding to each object of the plurality of objects.

In some embodiments, the sub-image adjustment module 708 comprises: a target evaluation result determining module, configured to determine a target evaluation result corresponding to a target sub-image among a plurality of sub-images; a sub-image occupancy proportion determining module, configured to determine the proportion of the target sub-image occupying the display area based on the target evaluation result; a target sub-image adjusting and target sub-area determining module, configured to determine the adjustment of the target sub-image and the target sub-area in the display area for displaying the target sub-image based on the proportion; and an adjusted target sub-image display module, configured to display the adjusted target sub-image in the target sub-area.

In some embodiments, the target sub-image adjusting and target sub-area determining module comprises: a target sub-image allocation module, configured to allocate the target sub-image to the target view component; and a target view component size adjusting module, configured to adjust the target sub-image by adjusting the size of the target view component based on the proportion.

In some embodiments, the target sub-image adjusting and target sub-area determining module comprises: a module for determining whether a proportion is greater than a threshold, configured to determine whether the proportion is greater than a threshold; and a target sub-image magnifying module, configured to magnify the target sub-image in response to the proportion being greater than the threshold.

In some embodiments, the adjusted target sub-image display module comprises: a module for removing the content in the enlarged target sub-image that exceeds the second height, configured to remove content in the enlarged target sub-image that exceeds the second height in response to the first height of the enlarged target sub-image exceeding the second height of the display area.

In some embodiments, the adjusted target sub-image display module comprises: a module for covering the content in the enlarged target sub-image that exceeds the second height, which is configured to cover the content in the enlarged target sub-image that exceeds the second height using a background image outside the display area in response to the first height of the enlarged target sub-image exceeding the second height of the display area.

In some embodiments, the target sub-image adjusting and target sub-area determining module also comprises: a module for determining a target sub-area size smaller than the target sub-image size, configured to determine that the size of the target sub-area is smaller than the target sub-image size in response to the proportion being smaller than a threshold; and a partial content display module of a target sub-image, configured to display partial content of the target sub-image in the target sub-area.

In some embodiments, the partial content display module of the target sub-image comprises: a content cropping module in the target sub-image that exceeds the target sub-area, configured to crop the content in the target sub-image that exceeds the target sub-area; or a module for hiding the content in the target sub-image that exceeds the target sub-area, configured to hide the content in the target sub-image that exceeds the target sub-area under other displayed content.

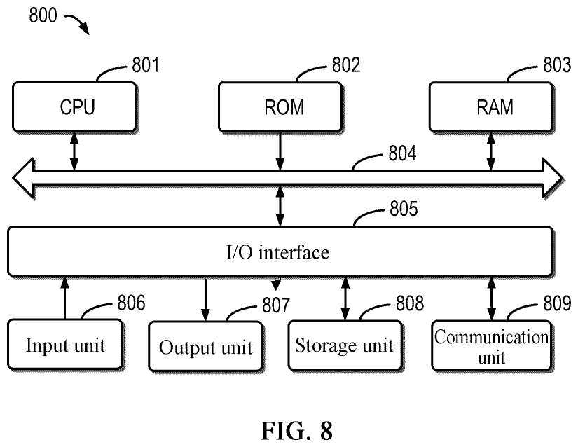

FIG. 8 shows a schematic block diagram of an example device 800 that can be used to implement embodiments of the present disclosure. The computing device 102 in FIG. 1 can be implemented using the device 800. As shown in the figure, the device 800 includes a central processing unit (CPU) 801, which can perform various appropriate actions and processes according to computer program instructions stored in a read-only memory (ROM) 802 or loaded from a storage unit 808 into a random-access memory (RAM) 803. Various programs and data required for the operation of the device 800 can also be stored in the RAM 803. CPU 801, ROM 802 and RAM The 803 are connected to each other via a bus 804. An input/output (I/O) interface 805 is also connected to the bus 804.

Various components in device 800 are connected to I/O interface 805, including an input unit 806, such as a keyboard and mouse; an output unit 807, such as various types of displays and speakers; a storage unit 808, such as a magnetic disk and optical disk; and a communication unit 809, such as a network card, a modem, a wireless communication transceiver, etc. Communication unit 809 allows device 800 to exchange information/data with other devices via a computer network such as the Internet and/or various telecommunication networks.

The various processes and processing described above, such as method 200 and examples 300 to 600, can be performed by the processing unit 801. For example, in some embodiments, method 200 and examples 300 to 600 can be implemented as a computer software program, which is tangibly contained in a machine-readable medium, such as storage unit 808. In some embodiments, part or all of the computer program can be loaded and/or installed on the device 800 via ROM 802 and/or communication unit 809. When the computer program is loaded into RAM 803 and executed by CPU 801, one or more actions of the example method 200 and examples 300 to 600 described above can be performed.

The present disclosure may be a method, an apparatus, a system and/or a computer program product. The computer program product may include a computer-readable storage medium carrying computer-readable program instructions for executing various aspects of the present disclosure.

A computer-readable storage medium can be a tangible device that can hold and store instructions used by an instruction execution device. A computer-readable storage medium can be, for example, but not limited to, an electrical storage device, a magnetic storage device, an optical storage device, an electromagnetic storage device, a semiconductor storage device, or any suitable combination thereof. More specific examples (a non-exhaustive list) of computer-readable storage media include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanical encoding device, such as a punch card or a raised structure within a groove on which instructions are stored, and any suitable combination thereof. As used herein, a computer-readable storage medium is not to be construed as a transient signal per se, such as a radio wave or other freely propagating electromagnetic wave, an electromagnetic wave propagating through a waveguide or other transmission medium (e.g., a light pulse passing through a fiber optic cable), or an electrical signal transmitted via wires.

The computer-readable program instructions described herein can be downloaded from a computer-readable storage medium to each computing/processing device, or downloaded to an external computer or external storage device via a network, such as the Internet, a local area network, a wide area network, and/or a wireless network. The network can include copper transmission cables, fiber optic transmission, wireless transmission, routers, firewalls, switches, gateway computers, and/or edge servers. The network adapter card or network interface in each computing/processing device receives the computer-readable program instructions from the network and forwards the computer-readable program instructions to be stored in the computer-readable storage medium in each computing/processing device.

Computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, including object-oriented programming languages such as Smalltalk, C++, and conventional procedural programming languages such as “C” or similar programming languages. The computer-readable program instructions may be executed entirely on the user's computer, partially on the user's computer, as a stand-alone software package, partially on the user's computer and partially on a remote computer, or entirely on a remote computer or server. In the case of a remote computer, the remote computer may be connected to the user's computer via any type of network, including a local area network (LAN) or a wide area network (WAN), or may be connected to an external computer (e.g., via the Internet using an Internet service provider). In some embodiments, the state information of the computer-readable program instructions is used to personalize an electronic circuit, such as a programmable logic circuit, a field programmable gate array (FPGA), or a programmable logic array (PLA), so that the electronic circuit can execute the computer-readable program instructions, thereby implementing various aspects of the present disclosure.

Various aspects of the present disclosure are described herein with reference to flowcharts and/or block diagrams of methods, devices (systems) and computer program products according to embodiments of the present disclosure. It should be understood that each block of the flowcharts and/or block diagrams, and combinations of blocks in the flowcharts and/or block diagrams, can be implemented by computer-readable program instructions.

These computer-readable program instructions can be provided to a processing unit of a general-purpose computer, a special-purpose computer, or other programmable data processing apparatus, thereby producing a machine such that when these instructions are executed by the processing unit of the computer or other programmable data processing apparatus, an apparatus is generated that implements the functions/actions specified in one or more blocks in the flowchart and/or block diagram. These computer-readable program instructions can also be stored in a computer-readable storage medium, where these instructions cause the computer, programmable data processing apparatus, and/or other device to operate in a specific manner. Thus, the computer-readable medium storing the instructions comprises an article of manufacture that includes instructions for implementing various aspects of the functions/actions specified in one or more blocks in the flowchart and/or block diagram.

Computer-readable program instructions may also be loaded onto a computer, other programmable data processing apparatus, or other device so that a series of operational steps are performed on the computer, other programmable data processing apparatus, or other device to produce a computer-implemented process, thereby causing the instructions executed on the computer, other programmable data processing apparatus, or other device to implement the functions/actions specified in one or more blocks in the flowchart and/or block diagram.

The flow charts and block diagrams in the accompanying drawings show the possible architecture, functions and operations of the systems, methods and computer program products according to a plurality of embodiments of the present disclosure. In this regard, each box in the flow chart or block diagram can represent a part of a module, program segment or instruction, and the part of the module, program segment or instruction contains one or more executable instructions for realizing the prescribed logical function. In some alternative implementations, the functions marked in the box can also occur in a sequence different from that marked in the accompanying drawings. For example, two consecutive boxes can actually be executed substantially in parallel, and they can sometimes be executed in the opposite order, depending on the functions involved. It should also be noted that each box in the block diagram and/or flow chart, and the combination of the boxes in the block diagram and/or flow chart can be implemented by a dedicated hardware-based system that performs the prescribed function or action, or can be implemented by a combination of dedicated hardware and computer instructions.

Embodiments of the present disclosure have been described above, the foregoing description is intended to be illustrative, non-exhaustive, and not limited to the disclosed embodiments. Many modifications and variations will be apparent to those skilled in the art without departing from the scope and spirit of the described embodiments. The terminology used herein is selected to best explain the principles of the embodiments, their practical applications, or technical improvements to existing technologies, or to enable others skilled in the art to understand the embodiments disclosed herein.

I/We claim:

1. A method for adjusting a video, comprising:
receiving a video stream, the video stream comprising a plurality of video frames;
generating, based on a video frame of the plurality of video frames, a plurality of sub-images, a sub-image of the plurality of sub-images being associated with an object of a plurality of objects in the video stream;
determining a plurality of evaluation results corresponding to the plurality of objects; and
adjusting, based on the plurality of evaluation results, the plurality of sub-images.

2. The method according to claim 1, wherein generating the plurality of sub-images comprises:
determining, based on metadata of the video frame, a position of the sub-image corresponding to the object of the plurality of objects in the video frame; and
obtaining, based on the position, the sub-image.

3. The method according to claim 2, wherein obtaining the sub-image comprises:
generating, based on the video frame, a copy of the video frame; and
obtaining, based on the position, the sub-image by cropping the copy.

4. The method according to claim 2, wherein the metadata comprises:
vertex coordinates, a height, and a width of a sub-image corresponding to each object of the plurality of objects.

5. The method according to claim 1, wherein adjusting the plurality of sub-images comprises:
determining a target evaluation result corresponding to a target sub-image among the plurality of sub-images;
determining, based on the target evaluation result, a proportion of display area occupied by the target sub-image;
determining, based on the proportion, an adjustment of the target sub-image and a target sub-area in the display area for displaying the target sub-image; and
displaying the adjusted target sub-image in the target sub-area.

6. The method according to claim 5, wherein determining the adjustment of the target sub-image and the target sub-area in the display area for displaying the target sub-image comprises:
assigning the target sub-image to a target view component; and
adjusting, based on the proportion, the target sub-image by adjusting a size of the target view component.

7. The method according to claim 5, wherein determining the adjustment of the target sub-image and the target sub-area in the display area for displaying the target sub-image comprises:
determining whether the proportion is greater than a threshold; and
enlarging the target sub-image in response to the proportion being greater than the threshold.

8. The method according to claim 5, wherein displaying the adjusted target sub-image in the target sub-area comprises:
removing, in response to a first height of the enlarged target sub-image exceeding a second height of the display area, content exceeding the second height in the enlarged target sub-image.

9. The method according to claim 5, wherein displaying the adjusted target sub-image in the target sub-area comprises:
covering, in response to a first height of the enlarged target sub-image exceeding a second height of the display area, content exceeding the second height in the enlarged target sub-image by a background image outside the display area.

10. The method according to claim 7, wherein determining the adjustment of the target sub-image and the target sub-area in the display area for displaying the target sub-image further comprises:
determining that a size of the target sub-area is smaller than a size of the target sub-image, in response to the proportion being smaller than the threshold; and
displaying partial content of the target sub-image in the target sub-area.

11. The method according to claim 10, wherein displaying the partial content of the target sub-image in the target sub-area comprises:
cropping content of the target sub-image exceeding the target sub-area; or
hiding content in the target sub-image exceeding the target sub-area under other displayed content.

12. An electronic device comprising:
at least one processor; and
a storage for storing at least one program, wherein the at least one program, when executed by the at least one processor, causes the at least one processor to:
receive a video stream, the video stream comprising a plurality of video frames;
generate, based on a video frame of the plurality of video frames, a plurality of sub-images, a sub-image of the plurality of sub-images being associated with an object of a plurality of objects in the video stream;
determine a plurality of evaluation results corresponding to the plurality of objects; and
adjust, based on the plurality of evaluation results, the plurality of sub-images.

13. The electronic device according to claim 12, wherein the at least one program causing the at least one processor to generate the plurality of sub-images comprises instructions to:
determine, based on metadata of the video frame, a position of the sub-image corresponding to the object of the plurality of objects in the video frame; and
obtain, based on the position, the sub-image.

14. The electronic device according to claim 13, wherein the at least one program causing the at least one processor to obtain the sub-image comprises instructions to:
generate, based on the video frame, a copy of the video frame; and
obtain, based on the position, the sub-image by cropping the copy.

15. The electronic device according to claim 13, wherein the metadata comprises:
vertex coordinates, a height, and a width of a sub-image corresponding to each object of the plurality of objects.

16. The electronic device according to claim 12, wherein the at least one program causing the at least one processor to adjust the plurality of sub-images comprises instructions to:
determine a target evaluation result corresponding to a target sub-image among the plurality of sub-images;
determine, based on the target evaluation result, a proportion of display area occupied by the target sub-image;
determine, based on the proportion, an adjustment of the target sub-image and a target sub-area in the display area for displaying the target sub-image; and
display the adjusted target sub-image in the target sub-area.

17. The electronic device according to claim 16, wherein the at least one program causing the at least one processor to determine the adjustment of the target sub-image and the target sub-area in the display area for displaying the target sub-image comprises instructions to:
assign the target sub-image to a target view component; and
adjust, based on the proportion, the target sub-image by adjusting a size of the target view component.

18. The electronic device according to claim 16, wherein the at least one program causing the at least one processor to determine the adjustment of the target sub-image and the target sub-area in the display area for displaying the target sub-image comprises instructions to:
determine whether the proportion is greater than a threshold; and
enlarge the target sub-image in response to the proportion being greater than the threshold.

19. The electronic device according to claim 16, wherein the at least one program causing the at least one processor to display the adjusted target sub-image in the target sub-area comprises instructions to:
remove, in response to a first height of the enlarged target sub-image exceeding a second height of the display area, content exceeding the second height in the enlarged target sub-image.

20. A non-transitory computer-readable storage medium having a computer program stored thereon, wherein the computer program, when executed by a processor, causing the processor to:
receive a video stream, the video stream comprising a plurality of video frames;
generate, based on a video frame of the plurality of video frames, a plurality of sub-images, a sub-image of the plurality of sub-images being associated with an object of a plurality of objects in the video stream;
determine a plurality of evaluation results corresponding to the plurality of objects; and
adjust, based on the plurality of evaluation results, the plurality of sub-images.
